(19) United States
(12) Patent Application Publication
(10) Pub. No.: US 2006/0200589 A1
(43) Pub. Date: Sep. 7, 2006

(54) Automated driver reset for an information handling system

(76) Inventors: Mark A. Collins, Dripping Springs, TX (US); Darryl Konopka, Austin, TX (US); Ricky G. Malone, Leander, TX (US); Robert H. Robertson, Cedar Park, TX (US)

Correspondence Address: HAMILTON & TERRILE, LLP, P.O. BOX 203518, AUSTIN, TX, 78720, US

(21) Appl. No.: 11/060,855

(22) Filed: Feb. 18, 2005

(51) Int. Cl. G06F 3/00

(52) U.S. Cl. 710/8

(57) ABSTRACT

A method and apparatus resetting device drivers to their factory-installed state, without requiring reinstallation of the operating system, to return the computer to a functioning condition. A back-up component is provided that backs-up and stores all associated device drivers, as originally installed by the computer manufacturer, onto non-removable media inherent to the computer system along with their preferred order of installation. A reset component is provided that retrieves the drivers from their storage location and resets, restores, or reinstalls the drivers as required, in their preferred order, as originally installed by the computer manufacturer. The reset component can be invoked automatically by a novice user, requiring little or no interaction, or it may be accessed through a graphical user interface (GUI) by a technician.

### BACKGROUND OF THE INVENTION

1. Field of the Invention

The present invention relates in general to the field of information handling systems and, more particularly, to an improved method and apparatus restoring device drivers in an information handling system to a predetermined state, such as the original, factory-installed state.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A computer system may include a variety of devices that which require specialized software, known as device drivers, or more generally, drivers. These drivers allow the devices to interact and operate with the computer's processor and other devices within the computer system. The devices, and their associated drivers, come from a variety of manufacturers and sources. The order in which the drivers are installed may be critical to avoid conflict with other devices and/or their associated drivers.

At present, device drivers can be corrupted or become malfunctioning, either through normal use of the computer, the innocent installation of new software including new device drivers, or the unintentional introduction of malicious programs such as computer viruses, or other causes. Resetting, reinstalling or restoring device drivers to their original, correctly functioning state can be complex, tedious, time consuming, and costly, especially for novice computer users. The driver resetting process is further exacerbated by the fact that the required drivers may be scattered across multiple distribution media including floppy disks, CD-ROMs and tapes. Some computer manufacturers include all of the required device drivers on a distribution CD-ROM, which can also be easily separated from the computer itself, causing similar delays, frustration and costs. The most common remedy for these problems is a complete reinstallation of the computer's operating system, adding device drivers in sequentially until the computer is restored to its normal operating state.

Therefore, there is a need for a system and method for resetting, reinstalling or restoring device drivers to their factory-installed state, automatically usable by a novice computer user, and/or with suitable controls for use by a knowledgeable technician, to recover device drivers and associated information from non-removable media inherent in the computer, without causing the need for a complete reinstallation of the operating system. Such a system is provided by the present invention, as described hereinbelow.

### SUMMARY OF THE INVENTION

The present invention overcomes the shortcomings of the prior art by providing a method and apparatus resetting device drivers to their factory-installed state, without requiring reinstallation of the operating system, to return the computer to a functioning condition. A back-up component is provided that backs-up and stores all associated device drivers, as originally installed by the computer manufacturer, onto non-removable media inherent to the computer system along with their preferred order of installation. The back-up component removes the need for the availability of drivers stored on removable media. A reset component is provided that retrieves the drivers from their storage location and resets, restores, or reinstalls the drivers as required, in their preferred order, as originally installed by the computer manufacturer. The reset component can be invoked automatically by a novice user, requiring little or no interaction, or it may be accessed through a graphical user interface (GUI) by a knowledgeable technician, who has the option of additional controls over the driver reset process.

Using the method and apparatus of the invention device drivers are reset, restored, or reinstalled to their original state, as originally installed by the computer manufacturer. Further, the invention provides additional controls to knowledgeable and capable technicians who require additional capabilities to resolve driver conflicts or conditions preventing functional operation of the computer.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of an automated system for installing software on an information handling system.

FIG. 2 is a system block diagram of an information handling system.

FIG. 3 is flowchart illustration of the sequence of steps to implement the driver reset process in accordance with the present invention.

### DETAILED DESCRIPTION

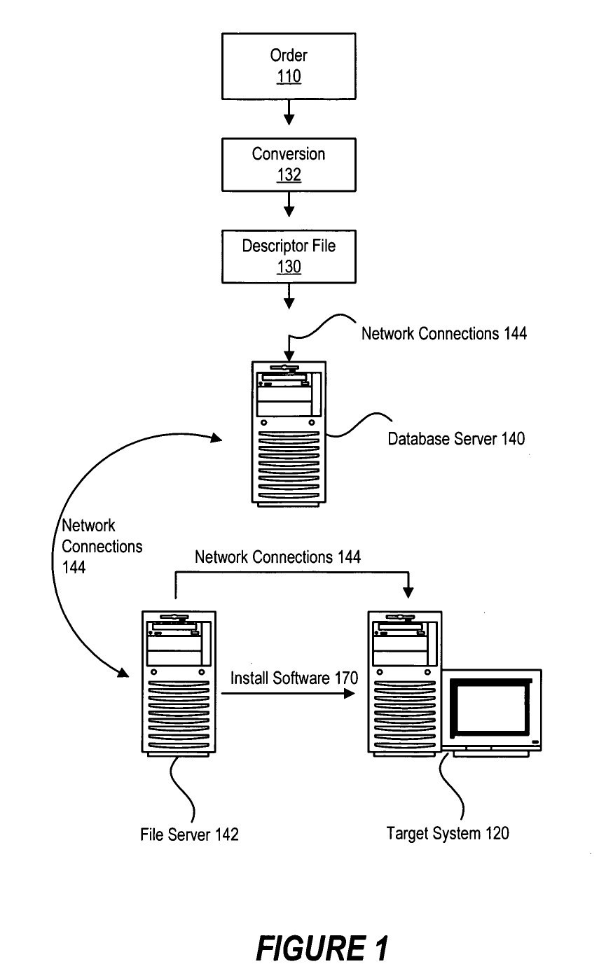

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor and software. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In an embodiment of the present invention, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120. Upon completion, the information handling system 120 will have a predetermined set of software, including predetermined set of drivers corresponding to the specific configuration of the information handling system.

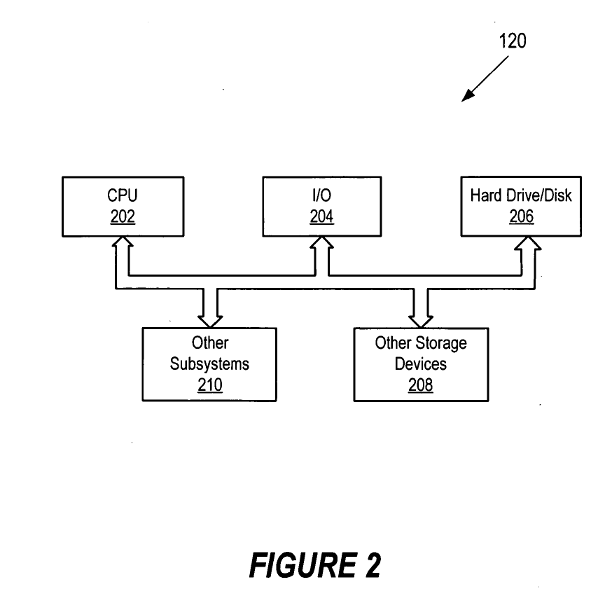

FIG. 2 is a generalized illustration of an information handling system, such as the target information handling system 120 illustrated in FIG. 1. The information handling system includes a processor 202, input/output (I/O) devices 204, such as a display, a keyboard, a mouse, and associated controllers, a hard disk drive 206, and other storage devices 208, such as a floppy disk and drive and other memory devices, and various other subsystems 210, all interconnected via one or more buses 212. The software that is installed according to the versioning methodology is installed onto hard disk drive 206. Alternately, the software may be installed onto any appropriate non-volatile memory. The non-volatile memory may also store the information relating to which factory build environment was used to install the software. Accessing this information enables a user to have additional systems corresponding to a particular factory build environment to be built.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

As was discussed above, the information handling system 120 typically leaves the manufacturing facility with a predetermined set of drivers corresponding to the specific configuration of the information handling system. For various reasons, these drivers can be corrupted or become malfunctioning, either through normal use of the computer, the innocent installation of new software including new device drivers, or the unintentional introduction of malicious programs such as computer viruses, or other causes.

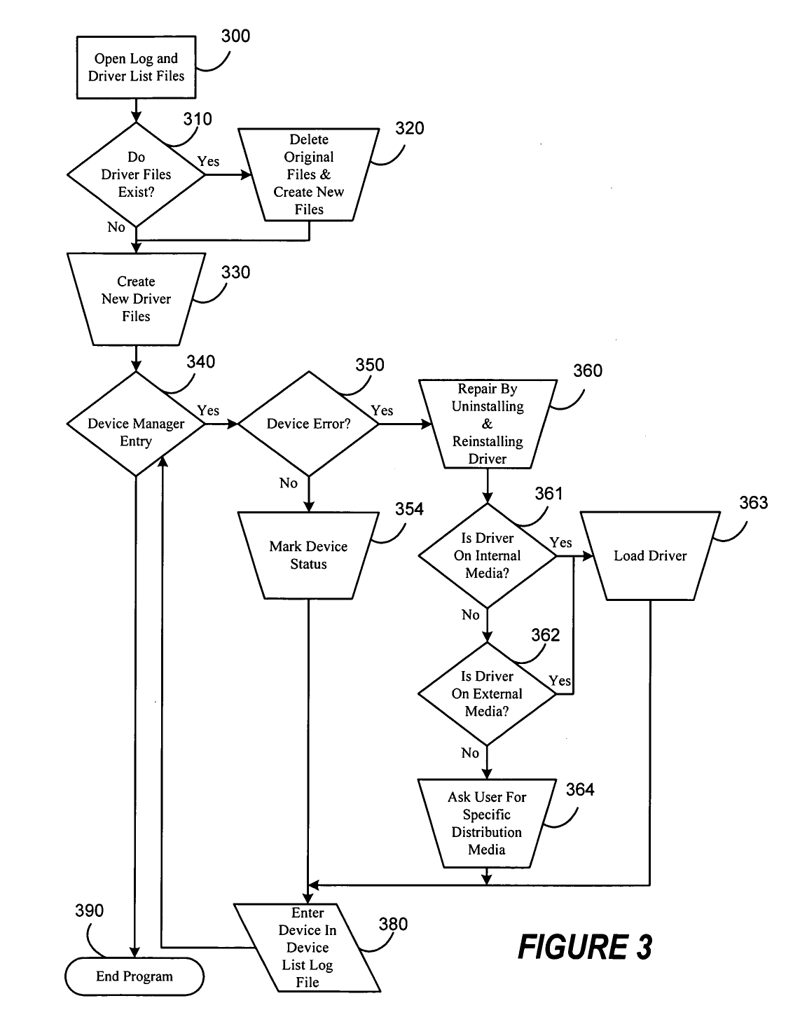

FIG. 3 is a flow chart illustration of the processing steps of the present invention for resetting the drivers on the information handling system 120 to the original factory configuration. When the computer is not functioning properly, and driver issues are suspected, the driver reset program is invoked at step 300 by the user or a knowledgeable technician, and a file log listing driver files is opened. In one embodiment of the invention, the file log is accessed through the Microsoft Windows Management Interface (WMI) inherent in the Windows 2000 and XP operating system. These operating systems automatically create a file back-up of device drivers in multiple folders of the computer's hard drive at time of installation for file protection.

In step 310 a test is conducted to determine if driver files exist and are registered on the information handling system. If the results of the test conducted in step 310 indicate that files do exist, the device driver file list is compared to the drivers installed on the computer and processing proceeds to step 320. If the driver files are installed and registered on the computer, the original driver files are deleted on the computer in step 320 and new driver files are created on the computer in step 330. If the test conducted in step 310 indicates that driver files are not installed or not registered on the computer, device driver files are created on the computer in step 330.

In one embodiment of the invention, the Device Manager 340 component of the Windows operating system is invoked once the driver files are created. In other embodiments, the corresponding device management component of the respective operating system is invoked. In step 350 a test is conducted to determine if any errors have occurred. If no device errors have occurred, the device status is marked in step 354 and the drivers are registered by entering the device driver into the list contained in the log file in step 380. If the result of the test conducted in step 350 indicates that errors have occurred, processing proceeds to step 360 and a repair is attempted by uninstalling and reinstalling one or more device drivers. In one embodiment of the invention, uninstalling and reinstalling takes place automatically with no manual intervention required. In another embodiment, manual control of the uninstall and reinstall process is invoked, usually by a technician, though a GUI.

A test is performed in step 361 to determine whether or not the required driver files are stored on non-removable media inherent to the computer system. If the result of the test conducted in step 361 indicates that the device driver files are present they are loaded in step 363 from the non-removable media and registered by entering the device into the device driver list contained in the log file in step 380. Once the log file has been successfully written, and the Device Manager has been updated, the program is complete and ended 390.

If the test conducted in step 361 indicates that the device driver files are not present on non-removable media, a test is performed 362, to see if the required device drivers are present on removable media accessible by the computer (e.g., floppy disk, CD-ROM, tape, etc.). In one embodiment, the required device driver files may be resident on another computer which can be accessed via network access. This network access may be automatically or manually invoked as necessary. If the required driver files are present on removable media that is accessible by the computer, they are loaded 363 from the removable media or network resource, and registered by entering the device into the device driver list contained in the log file 180. If the test conducted in step 362 indicates that the device drivers are not available on external media, processing proceeds to step 364 where the user is prompted to provide user-specific media. Once the log file has been successfully written in step 180 and the Device Manager has been updated, the program is complete and ended 190.

In one embodiment of the invention, a user can invoke the driver reset invention automatically with no further intervention. In another embodiment, a technician can invoke the driver reset invention from a graphical user interface (GUI) allowing additional or manual control over the driver reset operation. Those skilled in the art will appreciate that the invention can be implemented within many different computer systems, large and small, dedicated and general purpose. The invention can also be implemented within distributed computing systems, with the required device driver resources and driver reset invention resident on other computers, with the required instructions invoked manually or automatically, by machine, processes, and direct or indirect human action.

### Other Embodiments

Other embodiments are within the following claims.

For example, the above-discussed embodiments include software modules that perform certain tasks. The software modules discussed may include script, batch, or other executable files. The software modules may be stored on a machine-readable or computer-readable storage medium such as a disk drive. Storage devices used for storing software modules may be magnetic floppy disks, hard disks, or optical discs such as CD-ROMs or CD-Rs, for example. A storage device used for storing firmware or hardware modules may also include a semiconductor-based memory, which may be permanently, removably or remotely coupled to a microprocessor memory system. Thus, the modules may be stored within a computer system memory to configure the computer system to perform the functions of the module. Other new and various types of computer-readable storage media may be used to store the modules discussed herein. Consequently, the invention is intended to be limited only by the spirit and scope of the appended claims, giving full cognizance to equivalents in all respects.

Although the present invention has been described in detail, it should be understood that various changes, substitutions and alterations can be made hereto without departing from the spirit and scope of the invention as defined by the appended claims.

What is claimed is:

1. A system for restoring the operating state of an information handling system, comprising:
storage media comprising a restorable copy of device drivers used in the operation of said information handling system and an executable program for reinstalling said drivers in a predetermined configuration;
a processor operable to execute said program, thereby reinstalling said drivers on said information handling system in said predetermined configuration.

2. The system of claim 1, wherein execution of said program provides a test to determine if a predetermined set of driver files exists and to delete said predetermined set of drivers upon detection thereof, said program further being operable to create a new set of driver files after deleting said detected set of predetermined drivers.

3. The system of claim 2, wherein execution of said program provides an updated log of registered drivers upon installation of said new set of driver files.

4. The system of claim 1, wherein execution of said program provides detection of errors in the installation of said new set of drivers.

5. The system of claim 4, wherein execution of said program results in repair of said new set of drivers upon detection of errors in the installation thereof.

6. The system of claim 5, wherein the repair of said new set of drivers comprises uninstalling said new set of drivers and creating a repaired set of installed drivers.

7. The system of claim 1, wherein execution of said program provides for detection of whether the set of drivers to be installed is stored on internal media.

8. The system of claim 1, wherein execution of said program provides for detection of whether the set of drivers to be installed is stored on external media.

9. A method for restoring the operating state of an information handling system, comprising:
storing a restorable copy of device drivers used in the operation of said information handling system and an executable program for reinstalling said drivers in a predetermined configuration in a storage medium;
using a processor to execute said program, thereby reinstalling said drivers on said information handling system in said predetermined configuration.

10. The method of claim 9, wherein execution of said program provides a test to determine if a predetermined set of driver files exists and to delete said predetermined set of drivers upon detection thereof, said program further being operable to create a new set of driver files after deleting said detected set of predetermined drivers.

11. The method of claim 10, wherein execution of said program provides an updated log of registered drivers upon installation of said new set of driver files.

12. The method of claim 9, wherein execution of said program provides detection of errors in the installation of said new set of drivers.

13. The method of claim 12, wherein execution of said program results in repair of said new set of drivers upon detection of errors in the installation thereof.

14. The method of claim 13, wherein the repair of said new set of drivers comprises uninstalling said new set of drivers and creating a repaired set of installed drivers.

15. The method of claim 9, wherein execution of said program provides for detection of whether the set of drivers to be installed is stored on internal media.

16. The method of claim 9, wherein execution of said program provides for detection of whether the set of drivers to be installed is stored on external media.

17. An information handling system, comprising:
a data processor;
data storage having a driver file and an executable program stored thereon, said driver file and said executable program being transferred to said data storage by an automated software dissemination system; said executable program being operable to restore said driver file to a predetermined configuration upon execution of said program by said processor.

18. The system of claim 1, wherein execution of said program provides a test to determine if a predetermined set of driver files exists and to delete said predetermined set of drivers upon detection thereof, said program further being operable to create a new set of driver files after deleting said detected set of predetermined drivers.

19. The information handling system of claim 18, wherein execution of said program provides an updated log of registered drivers upon installation of said new set of driver files.

20. The information handling system of claim 17, wherein execution of said program provides detection of errors in the installation of said new set of drivers.

21. The information handling system of claim 20, wherein execution of said program results in repair of said new set of drivers upon detection of errors in the installation thereof.

22. The information handling system of claim 21, wherein the repair of said new set of drivers comprises uninstalling said new set of drivers and creating a repaired set of installed drivers.

23. The information handling system of claim 17, wherein execution of said program provides for detection of whether the set of drivers to be installed is stored on internal media.

24. The information handling system of claim 17, wherein execution of said program provides for detection of whether the set of drivers to be installed is stored on external media.
